(19) United States
(12) Patent Application Publication
(10) Pub. No.: US 2014/0211691 A1
(43) Pub. Date: Jul. 31, 2014

(54) SYSTEM AND METHOD FOR CHOOSING SUITABLE ACCESS POINTS IN QUIPS AUTARKIC DEPLOYMENT

(71) Applicant: QUALCOMM INCORPORATED, San Diego, CA (US)

(72) Inventors: Amir A. Emadzadeh, Campbell, CA (US); Sundar Raman, Fremont, CA (US); Young Shin Park, Stanford, CA (US)

(73) Assignee: QUALCOMM INCORPORATED, San Diego, CA (US)

(21) Appl. No.: 13/753,433

(22) Filed: Jan. 29, 2013

(51) Int. Cl. H04W 48/20

(52) U.S. Cl. CPC H04W 48/20
USPC 370/328

(57) ABSTRACT

This disclosure presents methods, systems, computer-readable media, and apparatuses for determining a limited but sufficient group of APs suitable to be used for efficient and accurate wireless device location fixing. Certain embodiments relate to methods for eliminating unsuitable APs even when the geographic position of APs in the area of interest is not known a priori.

### BACKGROUND

Aspects of the disclosure relate to methods for selecting suitable access points (AP) to be used in obtaining a location fix for a mobile device in an indoor area or other area of interest. The methods enable selection of suitable APs even when the geographic location of APs in the region is not known.

Obtaining a location fix for a mobile device has become a critically important function in recent years. For mobile devices, there are countless applications that take advantage of mobile device location fixing. For example, a map application can select appropriate maps, direction, driving routes, etc., based on the current location of a mobile device in which it resides. A social networking application can identify other users within the vicinity of a mobile device based on the location of the device. Many other examples exist.

Different techniques for obtaining a position fix for a mobile device may be appropriate under different conditions. In an outdoor environment, satellite-based approaches, e.g., GNSS (Global Navigation Satellite System) techniques, may be suitable if the mobile device is able to receive satellite-based positioning signals such that specific timing requirements are satisfied. Based on the received satellite signals a position fix for the mobile device may be calculated. However, satellite-based approaches may not used in indoor environments, because the necessary satellite signals typically may not be sufficiently strong to be received indoors.

In indoor environments such as those that exist with shopping malls, airports, sports arenas, etc., access point-based methods are generally more useful for obtaining a location fix for a mobile device. Commonly, a mobile device employing one of these methods observes signals sent to and/or from APs at known locations. Based on these observations, the device can determine data uniquely associated with individual access points, such as RSSI (Received Signal Strength Indication) and RTT (Round-trip Time). Such data allows the mobile device to estimate the distance between the device and the AP associated with the data. For example, the mobile device can then triangulate and estimate its own location, based on its determined proximity to multiple access points.

One problem with AP-based approaches is choosing which APs to use. With the proliferation of wireless networks, there is often a large number of APs (e.g., 500 APs) operating at a given moment within a particular indoor environment. However, many of the APs may not be suitable for fixing calculations or may not contribute data that is useful for the calculation. For example, an AP may be too far away from the wireless device or may be located so close to another AP involved in the fixing calculation that its information is redundant. Finally, some APs may not be suitable for use in obtaining a location fix because they are mobile APs and do not remain at any one location.

Furthermore, location calculations based on observations of signals such as RSSI and RTT are, generally speaking, computationally intensive. Because mobile devices have limited processing capabilities, power availability and memory resources, it may be impractical or unfeasible to perform such calculations for all APs within the range of a mobile device. For these reasons, it is desirable to identify APs which are suitable for use in location fixing, and to select just a small number of these suitable APs (e.g., 10 to 15 APs) for use in obtaining a mobile device location fix.

### BRIEF SUMMARY

Certain embodiments are described for selecting access points (APs) for use in obtaining a location fix for a mobile device. The embodiments generally involve receiving proximity data related to multiple access points identified by a set of MAC addresses, the proximity data calculated by a mobile device based on signals received at multiple locations in an indoor area, and the proximity data is indicative of distances between the multiple locations and the multiple access points, estimating AP locations based on the proximity data, selecting MAC addresses from the set, wherein selecting comprises pruning one or more MAC addresses from the set based on the estimated AP locations, and pruning one or more MAC addresses from the set based on the proximity data and without consideration of the estimated locations, and transmitting information to a mobile device, the information identifying the selected MAC addresses.

Certain embodiments also are described for obtaining a list of access points (APs) selected for use in obtaining a location fix for a mobile device, the method executable by a mobile device and comprising, at multiple locations in an indoor area, receiving signals from multiple access points identified by a set of MAC addresses, calculating proximity data based on the received signals, wherein the proximity data is indicative of distances between the multiple locations and the multiple access points, transmitting the proximity data through a network to facilitate selecting MAC addresses of the set to be used in obtaining a location fix, receiving a list of selected MAC addresses of the set, and obtaining a location fix using the selected MAC addresses.

### BRIEF DESCRIPTION OF THE DRAWINGS

Aspects of the disclosure are illustrated by way of example. In the accompanying figures, like reference numbers indicate similar elements, and:

FIG. 1 illustrates a simplified flow diagram depicts the generalized implementation of the methods of the present disclosure.

FIGS. 2A and 2B are block diagrams which each depict a wireless apparatus capable of implementing the methods of the present disclosure.

FIG. 2C is a block diagram depicting a remote server apparatus capable of implementing the methods of the present disclosure.

FIG. 3 is a flow diagram depicting an example methodology utilizable by a mobile device for determining a list of suitable access points, in accordance with the present disclosure.

FIG. 4 is a flow diagram depicting an example algorithm for pruning APs from a list of detected APs.

FIG. 5 is a flow diagram depicting an example algorithm for pruning APs from a list of detected APs.

FIG. 6A is a flow diagram depicting an example algorithm for pruning APs from a list of detected APs.

FIG. 6B is an area diagram with corresponding data which together depict how correlation can be used in accordance with methods of the present disclosure to determine that access points are located close to each other.

FIG. 7 is a flow diagram depicting an example algorithm for pruning APs from a list of detected APs.

FIG. 8 is a flow diagram depicting an example algorithm for pruning APs from a list of detected APs.

FIG. 9 is a flow diagram depicting an algorithm for estimating the location of detected APs based on proximity data.

FIG. 10A is a flow diagram depicting an algorithm for performing geometry-based centroid pruning of a list of detected APs.

FIG. 10B is an area diagram depicting example results of applying a geometry-based centroid pruning algorithm in accordance with the present disclosure.

FIG. 11 is a flow diagram depicting an example methodology for employing a remote wireless entity to implement certain aspects of the present disclosure.

FIG. 12 is a flow diagram depicting example operations executable by a remote server, in accordance with the present disclosure.

FIG. 13 is a flow diagram depicting example operations executable by a mobile device, in accordance with the present disclosure.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

The various embodiments of the present disclosure provide methods which may be employed to determine suitable access points to be used in fixing the location of a mobile device in an indoor environment. In accordance with certain embodiments, a list containing a limited but sufficient number of access points which are suitable for use in obtaining accurate mobile device location fixing may be determined. This list may be determined even when a priori knowledge of access point locations is not available. The number of access points on the list may be limited to prevent the processing of redundant, unreliable, inaccurate or unnecessary information, and without comprising the reliability or accuracy of the location fixing. Furthermore, certain embodiments enable this list to be determined without calculating or determining absolute access point locations (e.g., latitude/longitude), thereby saving processing resources. Other embodiments enable the absolute location of detected access points to be approximately estimated, and enable the list to be subsequently determined based on the estimated locations.

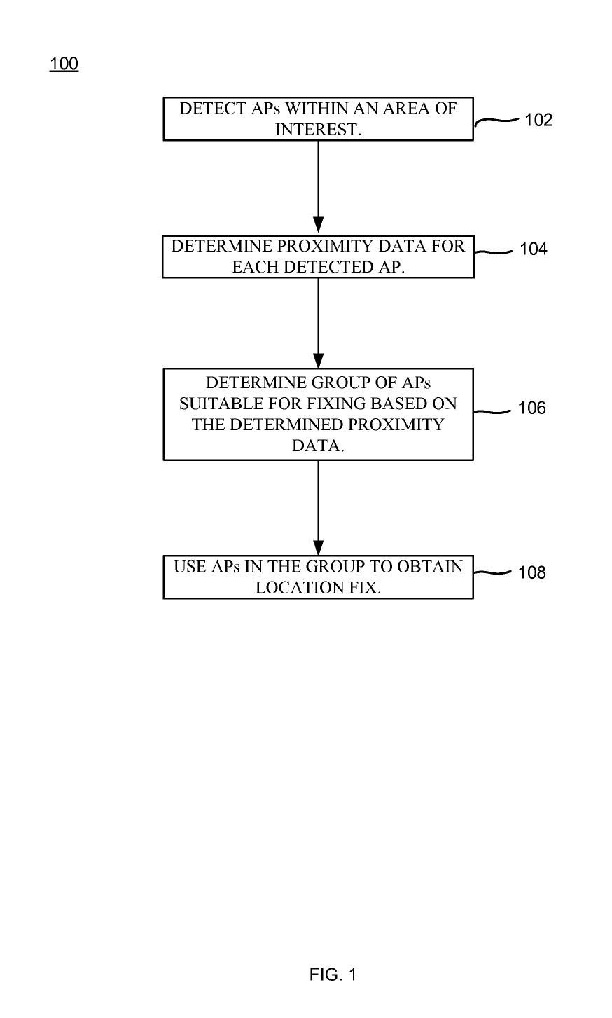

FIG. 1 is a simplified diagram providing a generalized depiction of the methods of the present disclosure. The methods of the present disclosure may involve the use of any combination of the several algorithms disclosed herein. Alternatively, in accordance with the present disclosure, any single algorithm disclosed herein may be utilized by itself or in conjunction or sequence with other algorithms already known in the art or which may be conceived of at some time in the future. As depicted in FIG. 1 at 102, the methods of the present disclosure may involve accessing information which identifies detected APs in an indoor area or in another area of interest within which a mobile device location fix will be determined. The methods also involve accessing or measuring proximity data indicative of the separation between a mobile device and the various detected APs, as described at 104. In cases in which the area of interest is a large indoor area such as a shopping mall or airport, it may be beneficial if the proximity data results from measurements taken in the various corridors of the building, as well as near shops or other important building areas.

Commonly, accessing AP information and accessing or measuring proximity data (as depicted at 102 and 104) is performed by a mobile measurement device configured especially for such purpose. Additionally or alternatively, these processes may be performed by a user operated device which may require a location fix to be performed. A user operated device may be, for example, a tablet, mobile phone, mobile wireless device, smart phone, PDA, etc.

The determined proximity data may be signal strength indicator (RSSI) data and/or round trip time delay (RTT) data, as well as data derived from time stamps included with the signals used for data determination. This data may be stored in any format suitable for future utilization at the device which gathers it. Additionally or alternatively, the data may be stored in a format which allows for it to be sent to, and processed by, a remote entity capable of executing certain of the additional processes or algorithms disclosed herein.

At 106, the methods involve analyzing the proximity data, as well as other data in some cases, to identify a limited number of detected APs which, when used together by a mobile device for location fixing, enable reliable, accurate and computationally-efficient fixing to be performed. Identifying this limited number of APs may involve initially pruning, discarding, or otherwise removing from consideration APs for which RSSI data is below a threshold level. It may also involve identifying certain manufacturer information related to APs, and removing certain APs from consideration which have been produced by manufacturers whose products are not suitable for mobile device location fixing.

A further embodiment may involve removing those APs from consideration which have SSIDs which do not coincide with a primary network known to be installed in the area of interest. Subsequently, any one or combination of other pruning algorithms which will be disclosed in following paragraphs may be applied to identify and prune additional APs not suitable for inclusion in the limited group of APs to be used for mobile device location fixing.

Analysis of the proximity data and identification of the limited number of APs may be done at the mobile measuring device or mobile apparatus used to detect the APs and gather or determine proximity data. Alternatively, the analysis and identification may be performed by any remote entity to which the AP identification and proximity data is provided. For example, after proximity data is gathered by a mobile measuring device or mobile apparatus at 104, it may be delivered or communicated to a remote server. At 106, the remote server may analyze the data and identify the limited number of APs for location fixing. When a remote entity provides the determination depicted at 106, information must be exchanged or transported between the remote entity and one or more wireless devices so that the devices may distinguish and obtain fixing information from the APs identified by the remote entity. This exchange of data is not depicted in FIG. 1, but will be discussed in more detail with reference to subsequent figures and paragraphs.

As depicted at 108, after the limited number of APs for location fixing is determined, information identifying the selected APs is employed by one or more wireless devices to obtain location fixing. The wireless devices employing the AP identity information may include the mobile measuring device or other mobile apparatus used, at 102 and 104, to detect APs and gather proximity data. Other wireless devices may also be provided with, and employ the AP identity information for location fixing in the manner described at 108.

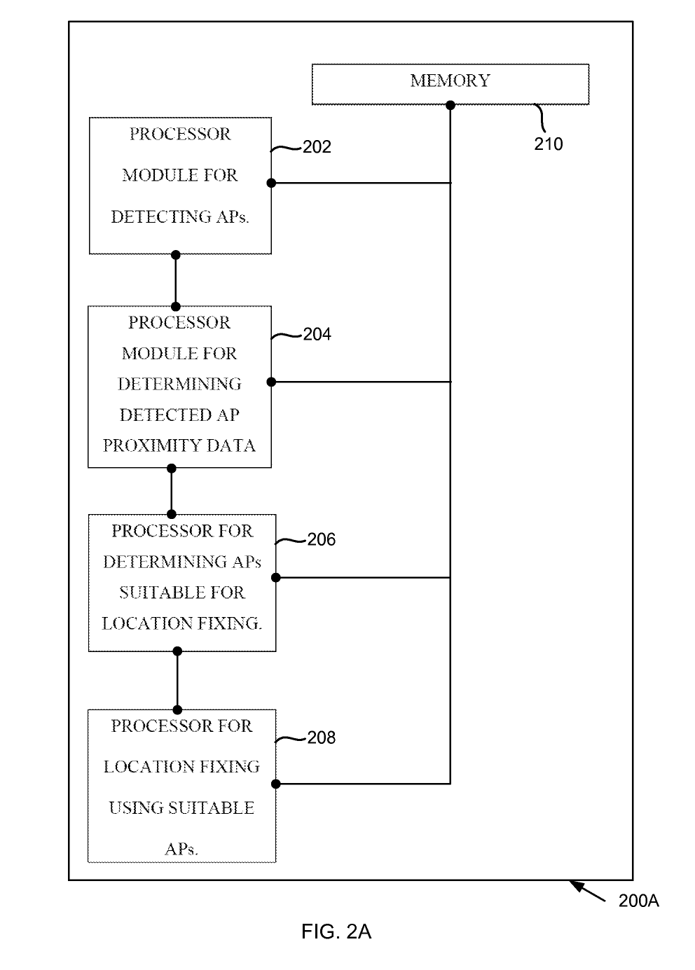

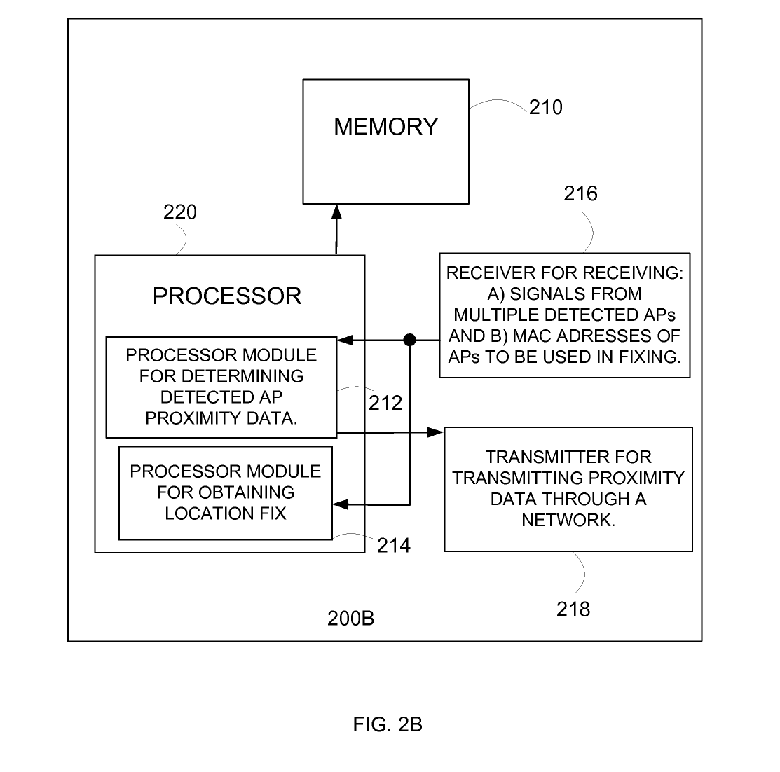

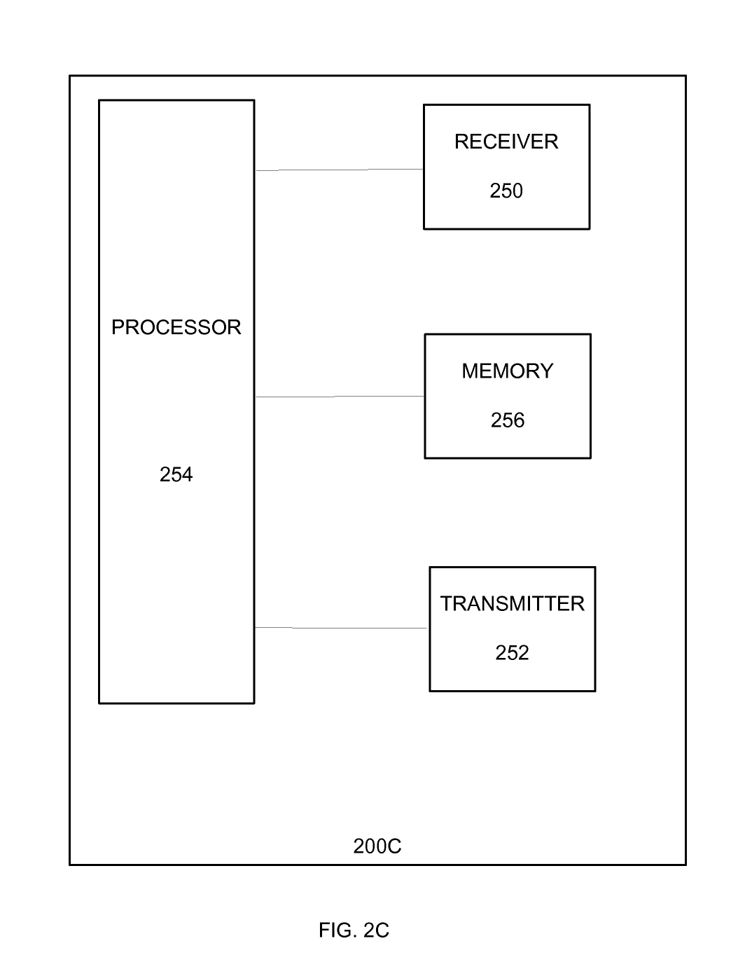

FIG. 2A illustrates a simplified diagram of an example system 200A capable of implementing one or more aspects of this disclosure in order to identify a small number of detected APs which are suitable and sufficient for efficient and accurate mobile device location fixing. As used herein, the term “AP” will denote any type of access point within an indoor or outdoor area of interest where mobile device location fixing may be performed. For example, the term shall be understood to include piconet base stations, wireless hotspots, wireless routers, relay stations, or other similarly disposed wireless network nodes or entities. The system 200A of FIG. 2a may be disposed within a mobile device such as a cellular phone, smart phone, tablet, laptop computer, or any other mobile hardware unit configured to send or receive wireless communications.

However, this disclosure is also directed to systems which reside apart from a mobile device and operate using data exchanged via communications sent to and/or from one or more mobile devices, or APs. For example, a network server or computer may operate in conjunction with a mobile device to perform or execute certain of the calculations or algorithms disclosed herein. In accordance with this disclosure, a server of this type may directly or indirectly provide results of the calculations or algorithms to wireless devices capable of utilizing the results for obtaining a location fix.

However, for simplicity and ease of explanation, and without limiting the scope of this disclosure in any way, the subsequent discussion will primarily describe arrangements in which the methods, algorithms and calculations of this disclosure are performed at a single mobile device, except where otherwise stated.

As depicted at 202, the system may involve a processor module for detecting APs in the area of interest. The processor module 202 may operate by processing information obtained from detected signals to identify access points in the area.

By way of one example, the processor module 202 may detect an access point at least in part by decoding a MAC address associated with the access point. When a MAC address is decoded, it may be stored in memory. Additionally, in certain embodiments, other processor modules in the system 200A, i.e. processor modules 204, 206 and 208, may use the MAC address as a reference to the access point associated with the address, and as part of sorting data, storing information, or performing other computational or algorithmic steps or processes in accordance with the present disclosure. Additionally, in certain embodiments, the processor module 202 may be capable of interacting with memory 210 to create, access, store, or revise any number of lists containing detected access points or associated MAC addresses.

As further depicted at 204, system 200A may also incorporate a processor module 204 for obtaining proximity data. This processor module 204 may operate by processing information obtained from multiple detected signals to determine or calculate data indicative of mobile device proximity to detected APs. By way of example only, such proximity data may include relative signal strength indication (RSSI) data or round trip time (RTT) data. During any one period of time, processor module 204 may perform computations associated with determining proximity data for any number of APs and may incorporate or utilize MAC address information in these processing steps. As depicted, the processor module 204 may be communicatively coupled or linked to one or more memory units and may use MAC address information in conjunction with causing AP proximity data to be written to or extracted from memory, exchanged with, or communicated to other processor modules 202, 206, 208 or any other system components not depicted in FIG. 2.

System 200A may also include a processing module 206 for analyzing proximity data and determining the limited group of APs which are suitable for accurate and reliable location fixing. Processing module 206 may analyze proximity data determined or calculated by processing module 204, and may access this data from memory. Alternatively or additionally, the proximity data may be received directly from processing module 204. In certain embodiments, the processing module 206 may function, at least at times, without calculating or estimating absolute location information for detected APs. In other embodiments, the processing module 206 may, at times, perform such calculations or estimates and utilize them in determining the limited group of APs which are suitable for location fixing.

By way of example only, both processing modules 204 and 206 may be configured for consolidating, aggregating, segmenting, storing, pruning, sorting, truncating, scanning, creating, erasing or otherwise using lists, arrays, trajectories, vectors, or any other such structures capable of holding access point data, mobile device location data, mobile device-AP proximity data, access point MAC address information, or any other data or information necessary to implement or execute the methods and algorithms disclosed herein.

System 200A may also include a processor module 208 for calculating a mobile device absolute location (i.e. location fixing) using information or signaling from APs within the limited group of suitable APs determined by processor module 206.

FIG. 2b depicts an alternative mobile device 200B capable of executing certain methods and techniques of this disclosure in conjunction with a remote and interoperable network server or computing device. Mobile device 200B may include a processor 220, receiver 216, transmitter 218 and memory 210. Receiver 216 may be used to detect signals from multiple APs within the area of interest where mobile device location fixing is desired. As depicted, information from the detected signals may be used by processor module 212, which may decode AP MAC address information from the signals. The processor module 212 may determine AP proximity data from these or other signals sent by the APs and detected by receiver 216. Processor module 212 may use the MAC address information to build a library or list containing information which individually identifies each detected AP and depicts the proximity data which corresponds to each identified AP.

Subsequently, transmitter 218 may be used to transmit the library or list to an external entity, which may process the information therein. The processing by the external entity may be done in order to identify a limited number of the detected APs which are suitable to be used by mobile device 200B for location fixing. Additionally or alternatively, information about the limited number of detected APs identified as suitable for location fixing may be used by other APs for location fixing in the area of interest.

Once the external entity has determined the limited number of suitable APs for location fixing, the MAC identifiers of the selected APs may be transmitted to mobile device 200b, as well as to any other mobile device. At mobile device 200B, receiver 216 may receive signals containing the MAC addresses of the selected APs. Subsequently, processing module 214 may use the MAC addresses to identify the selected APs, and calculate a location fix based on signals transmitted from the APs.

FIG. 2C depicts a remote server apparatus capable of executing certain methods and techniques of this disclosure in conjunction with one or more mobile measuring devices and user operated mobile device. Server 200C may include a processor 254, receiver 250, transmitter 252 and memory 256. Receiver 250 receives AP identifier information for several APs detected by a mobile measuring device or other mobile device, such as mobile device 200c, in an area where mobile device location fixing is desired. The AP identifier information may be MAC addresses, for example. Receiver 250 may also receive AP proximity data for each of the detected APs. Both the AP identifier data and the AP proximity data may be transmitted to server 200c by the mobile measure device or other mobile device, as the case may be.

After being received by receiver 250 at remote server 200C, the AP identifier information and the AP proximity data may be provided to processor 254. The identifier information and proximity data is used by processor 254 to identify a limited number of the detected APs which are suitable to be used by a mobile device for location fixing in the area of interest. Processor may access and use memory 256 as part of identifying the limited number of APs which are suitable for location fixing.

Once the limited number of suitable APs for location fixing is determined by processor 254, transmitter 252 may be used to transmit information identifying the selected APs to mobile device 200B, as well as to any other mobile device. Subsequently, mobile device 200B or any other receiving mobile device may use the MAC addresses to identify the selected APs, and calculate a location fix based on signals transmitted from the APs.

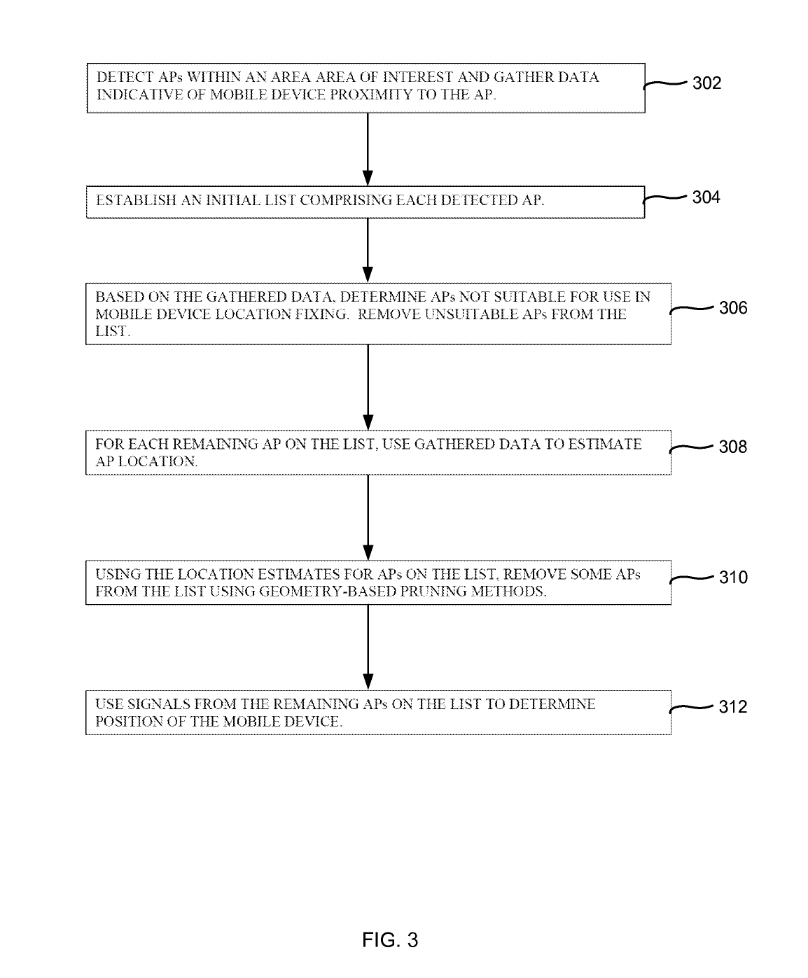

FIG. 3 is a generalized flow diagram depicting a first example methodology utilizable by a mobile device for determining the limited list of suitable access points for use in location fixing, in accordance with the present disclosure. At 302, a mobile device within an area of interest detects access points and observes communications sent to the access points and/or signals transmitted by the access points. Based on these observations, the mobile device calculates, determines or otherwise gathers data indicative of the mobile device's proximity to individual detected access points. The data indicative of proximity may be, for example, received signal strength indicator (RSSI) data, round trip time (RTT), or other data determined from signals observed from the detected access points. At 304, the mobile device establishes an initial list comprising each detected AP. Subsequently, at 306, the mobile device uses the gathered proximity data to determine APs not suitable for use in the process of determining the position of the device. These APs which are determined to be unsuitable are pruned from the list. At this point, signals from the APs on the pruned list may be used by the mobile device for determining its position.

Certain APs may not be suitable for use for a variety of different reasons. For example, in an environment in which many APs are concentrated, several APs may be clustered near each other. In this case, the use of more than one of the clustered APs may yield redundant data which, when processed, wastes processing resources. Separately, certain APs may be mobile or may provide unreliable signal strength. Such APs are unsuitable for determining mobile device position because their mobility, weak signals, or potential displacement from the device can cause unreliability or fixing inaccuracies to occur. Moreover, the use of mobile AP signals for fixing requires additional resources to be spent on updating the location of a mobile AP.

In an embodiment, the mobile device may further prune the list of APs using techniques which involve estimating the location of each remaining AP on the pruned list, and then removing additional APs using “geometry-based” pruning. In another embodiment, geometry-based pruning of the list of detected APs is the only pruning performed in generating the group of APs which are suitable for fixing. In either case, APs remaining on the list following geometry-based pruning can then be used by the mobile device for location fixing.

AP location estimating procedures and geometry-based pruning procedures are also described in FIG. 3. For example, at 308, following the initial pruning described at 306, the mobile device may use the proximity data to estimate a location for each AP remaining on the list. Subsequently, at 310, the location estimates are used to perform geometry-based pruning by removing additional APs from the list. Detailed algorithms for performing the estimations and pruning at 308 and 310 will be described with greater specificity in later paragraphs and with reference to additional figures. As previously mentioned, APs remaining on the pruned list of detected APs following geometry-based pruning may then be used to determine mobile device location, as described at 312.

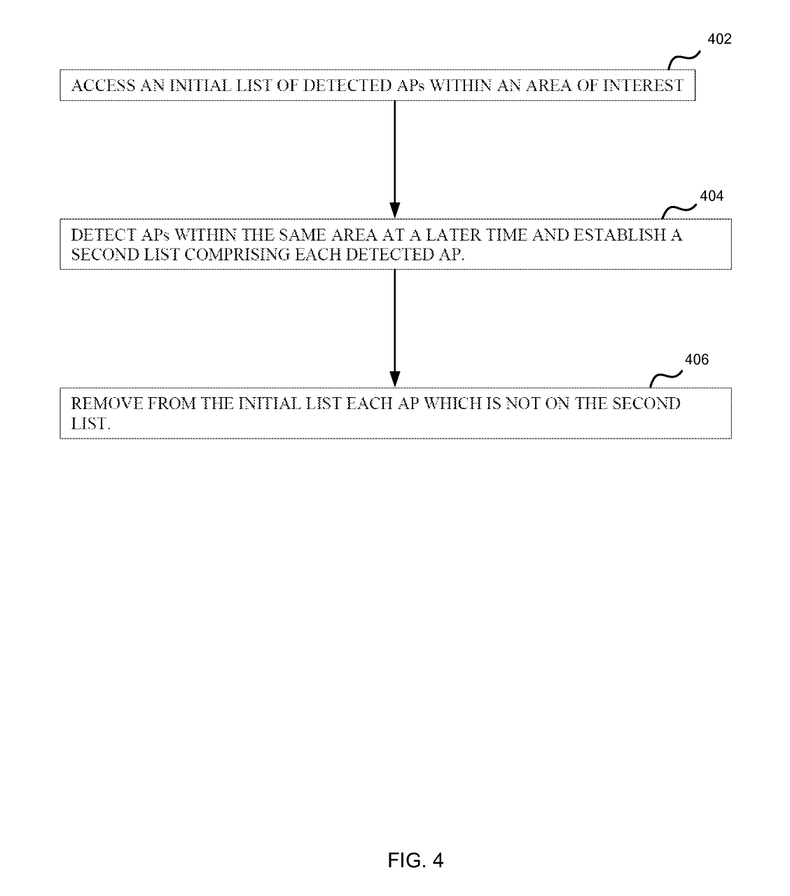

FIG. 4 is a flow diagram depicting an example algorithm for pruning APs from a list of detected APs within an indoor venue or other similar area for which it is desired to ascertain APs which are suitable for wireless device fixing. The algorithm described in FIG. 4 does not require the locations of detected APs to be known a priori, nor does it require the locations to be estimated by the mobile device. The algorithm is especially useful for identifying mobile APs which are unsuitable for use in determining mobile device position because of their potential for movement.

At 402, the mobile device accesses an initial list of APs previously detected within the area of interest. As depicted at 404, sometime well after the initial detections of the APs on the list, the mobile device again scans for all detectable APs in the area of interest and establishes a second list comprising the APs it detects.

In certain embodiments, it may be desirable for the mobile device to execute the procedures described at 404 after a substantial time lapse subsequent to formation of the initial list of detected APs. For example, a mobile device may detect the APs on the initial list in the morning of a given day, and may wait until the evening to detect APs for the second list, as part of the procedures described at 404. Such a time lapse may provide sufficient opportunity for mobile or intermittently operating APs to be removed from the area of interest or cease operations. If such an AP is removed or ceases operations during the time lapse, it will not be detected at 404, and will not appear on the second list of detected APs. Thus, at 406, the initial list is pruned by removing all APs on the list which do not also appear on the second list.

Alternatively, the pruning described at 406 may be done by a remote server capable of accessing the information contained in the initial list and the second list. In this case, the identities of the APs remaining on the pruned list may be communicated, using MAC addresses, to the wireless device or any other wireless entity.

Following the pruning at 406, signals from APs remaining on the pruned list may be relied on by the mobile device in the process of location fixing. Alternatively, the list may be further pruned using any one or combination of the other pruning algorithms described in this disclosure.

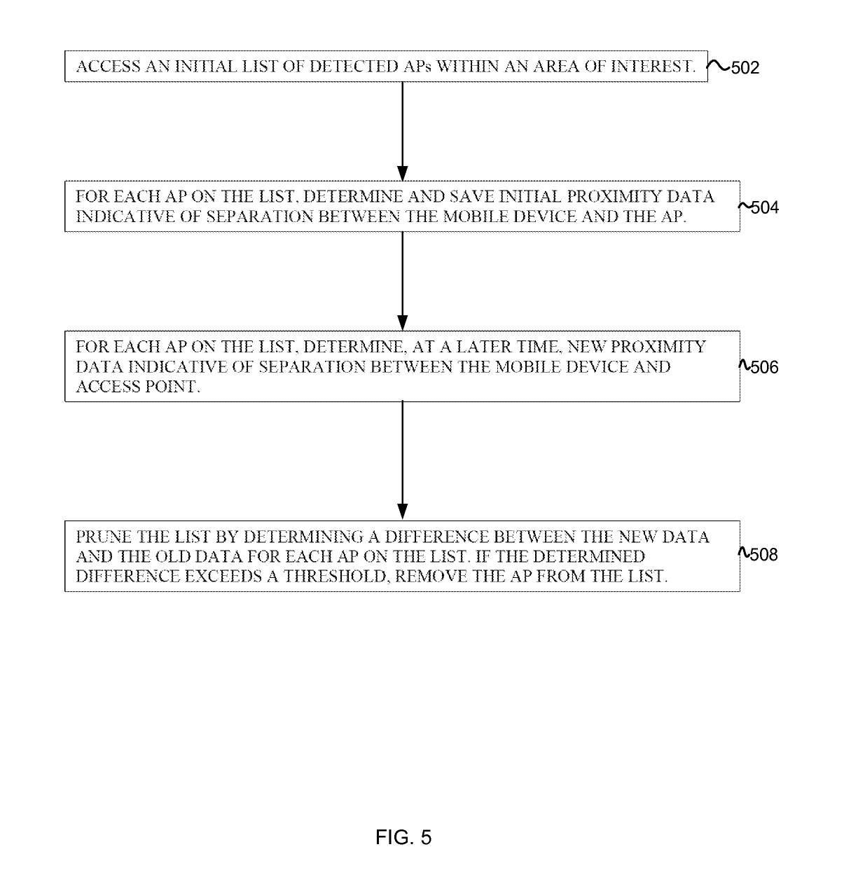

FIG. 5 is another flow diagram depicting an example algorithm for pruning APs from a list of detected APs within an indoor venue or other similar area for which it is desired to ascertain APs suited for use in location fixing. As is the case for all pruning algorithms presented herein, the algorithm of FIG. 5 may be used by itself, or in combination with any number of the other pruning algorithms of this disclosure, in order to generate a final list of APs which are suitable for a mobile device to use in determining its position. The algorithm of FIG. 5 does not require a mobile to have a priori knowledge of the location of any APs, nor does it require the device to estimate or determine any AP locations. The algorithm is especially useful for the detection of mobile APs and APs providing an unreliable signal, both of which are unsuitable for use in determining mobile device position.

As depicted at 502, the pruning algorithm involves the mobile device first obtaining the initial list of detected APs within the indoor area, or other area of interest, as the case may be. As described at 504, for each of the APs on the initial list, the mobile device then calculates and saves initial data indicative of the separation distance between the mobile device and the AP (proximity data). This data may be RSSI data, RTT data, or any other suitable data indicative of mobile device proximity to the associated AP. The initial proximity data may be computed or ascertained based on signals which are transmitted to or from the APs on the initial list and are observed by the mobile device. Sometime later, as depicted at 506, the mobile device determines updated data indicative of the separation distance between it and each AP on the initial list.

For reasons similar to those discussed with regards to FIG. 4, it may be desirable for the mobile device to determine the new data, at 506, only once a substantial time lapse has followed the determination of the initial data in 504. For example, in one embodiment, the initial data determined at 504 may be determined in the morning of a given day, while the updated data determined at 506 may be determined in the afternoon of a given day.

After new data has been obtained at 506, the list may be pruned by removing APs corresponding to proximity data which exhibits excessive variation. In an aspect of the algorithm of FIG. 5, the variation of an AP's proximity data may be determined by comparing the new proximity data to the initial proximity data. Pruning of APs with excessive variation may involve determining if a percentage of difference between an AP's new and initial proximity data is more or less than an established threshold, and removing an AP based on this determination.

Alternatively, the pruning described at 506 may be done by a remote server capable of accessing the initial and updated data. In this case, the identities of the APs remaining on the pruned list may be communicated, using MAC addresses, to the wireless device or any other wireless entity.

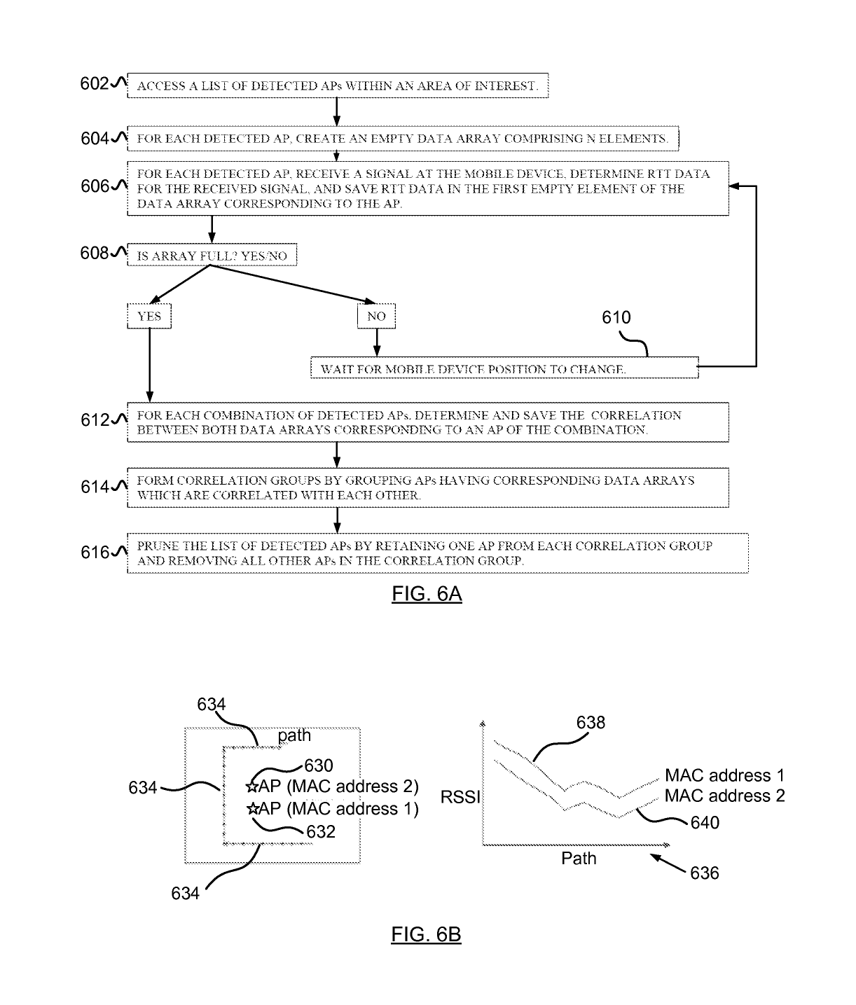

FIG. 6A is an additional flow diagram depicting another example algorithm which uses correlation between sets of accumulated AP proximity data to identify a limited group of APs suitable for mobile device position fixing. The algorithm of FIG. 6A does not require a mobile to have a priori knowledge of the location of any APs, nor does it require the device to determine any AP locations. This algorithm is especially useful in identifying and pruning APs which are clustered in proximity to other detected APs, and thereby enables a mobile device to save processing resources that otherwise would be wasted by relying on APs which provide redundant information.

At 602, the mobile device obtains an initial list of detected APs within the indoor area, or other area of interest, as the case may be. At 604, for each detected AP on the list, the mobile device creates an empty data array such that each array contains an equal number of data elements, or data storage locations. Then, at 606, while the device is at a first position, it seeks to receive a signal from each AP on the list. For each received signal, RTT data is calculated and associated with the AP from which the signal was transmitted. However, in an aspect of this algorithm, RSSI data or other similar data indicative of proximity to the associated transmission point may be used instead of RTT data. For each AP, the determined RTT data is saved in the first empty element of the data array corresponding to the AP. Subsequently, at 608, a determination is made as to whether the arrays are full. If the arrays are not full, the mobile device waits for its position to change and then repeats the procedures described at 606 until the arrays are full.

After performing the procedures described at 606, if the arrays are full at 608, the mobile device calculates correlation coefficients associated with each possible combination of two data arrays, as described at 612. At 614, the mobile device groups the APs such that the data array of each AP is correlated with the data array of every other AP in its group. By grouping APs according to correlation, APs which have similar locations will tend to be placed in the same group because, when measured at several locations, proximity data for an AP will tend to be correlated with proximity data measured at the same locations for nearby APs. Moreover, there will tend to be little or no correlation between data corresponding to APs which are not close to each other. Thus, the correlation grouping performed at 614 is a way to sort APs based on location without actually determining the location of any of the sorted APs.

The fact that correlation grouping enables this type of sorting may be understood by reference to FIG. 6B. In FIG. 6B, AP 630 is located near AP 632. The mobile device measures proximity data for each of these APs at the locations depicted at 634. The graph 636 displays plots 638 and 640 which represent the various signal strengths determined at these locations for APs 630 and 632, respectively. The plots 638 and 640 are clearly correlated with each other. This correlation is the result of the minimal separation between AP 630 and AP 632.

Following correlation grouping, pruning of the initial list is performed at 616 by retaining one AP from each correlation group, and removing all other APs from the list. Pruning based on the correlation groups in this manner may remove APs which are located close to the retained APs and which, due to their proximity, would provide redundant location fixing data if used in a mobile device location fixing calculation. The pruned list, therefore, can be expected to exhibit greater locational dispersion of APs and reduced clustering of APs as compared to the initial list prior to pruning.

Alternatively, the calculating, sorting and pruning described at 612-616 may be done by a remote server capable of accessing or receiving the array information used in these procedures. In this case, the identities of the APs remaining on the pruned list may be communicated, using MAC addresses, to the wireless device or any other wireless entity.

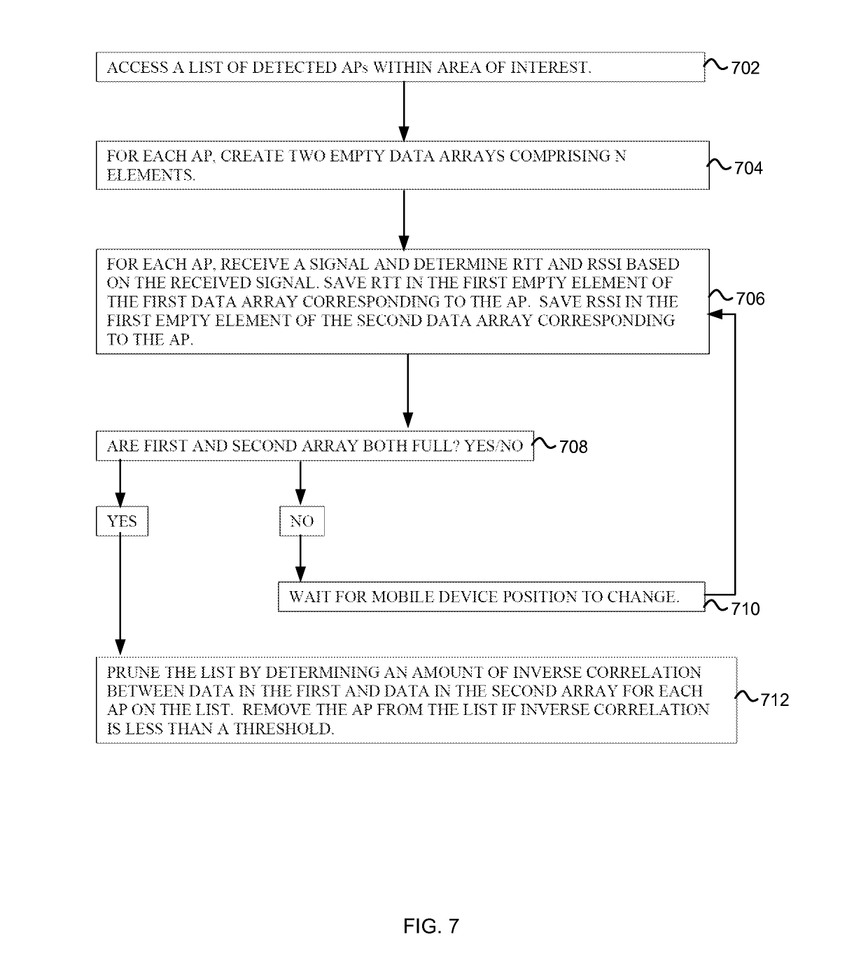

FIG. 7 is an additional flow diagram depicting an alternative example algorithm for pruning APs from a list of detected APs within an indoor venue or other similar area within which it is desired to ascertain APs suited for use in determining wireless device position. The algorithm of FIG. 6 does not require a mobile device to have a priori knowledge of the location of any APs, nor does it require the device to determine any AP locations. Difficulty in calculating reliable proximity data using signals sent to or from an AP may be a good indication that the AP is not suitable for use in mobile device location fixing. Based on this reason, the algorithm determines the reliability of calculated proximity data, and prunes APs which are associated with data determined to be unreliable.

The algorithm of FIG. 7 begins at 702 by a mobile obtaining or accessing the initial list of detected mobile devices within the indoor area, or other area of interest, as the case may be. For each AP on the initial list, the mobile device creates two empty data arrays, as described at 704. Each of the data arrays comprises an identical number (N) of data elements. One of the two data arrays is created to store subsequently determined RTT data and one of the data arrays is created to store subsequently determined RSSI data.

At 706, for each detected AP on the initial list, the mobile device receives a signal or series of signals sent to or transmitted by the AP. The mobile device determines RSSI and RTT data based on these signals. The RTT data for the AP is saved in the first empty element of the RTT data array associated with the AP, while the RSSI data is saved in the first empty element of the RSSI data array associated with the AP. At 708, the mobile device determines if all of the RTT and RSSI data arrays are full. If the data arrays are not full, the mobile device waits for its position to change at 710, and then repeatedly executes the procedures described at 706, 708 and 710, in that order, until the data arrays are full.

In cases where both the determined RTT and RSSI data is reliable for determining the mobile device's proximity to the AP associated with the data, the RTT data will tend to exhibit a strong inverse correlation with the RSSI data. Thus if RSSI for an AP increases substantially (thereby indicating decreasing distance between the mobile device and the associated AP), the decrease should be accompanied by a corresponding decrease in determined RTT. The lack of a corresponding decrease in determined RTT where there is a substantial increase in RSSI is an indication that either the determined RTT or the determined RSSI is not reliable. Thus, a lack of inverse correlation between the determined RTT and RSSI data for a detected AP is indicative of an inaccurate RTT or RSSI determination.

Returning now to FIG. 7, once data arrays are all full, the inverse correlations between RTT and RSSI data are determined at 712 and used in pruning APs from the initial list of detected APs. Specifically, for each AP, the amount of inverse correlation between the corresponding RTT data array and RSSI data array is calculated. If the inverse correlation is less than a threshold amount, the AP is pruned from the list.

Alternatively, the calculating and pruning described at 712 may be done by a remote server capable of accessing or receiving the array information used in these steps. In this case, the identities of the APs remaining on the pruned list may be communicated, using MAC addresses, to the wireless device or any other wireless entity.

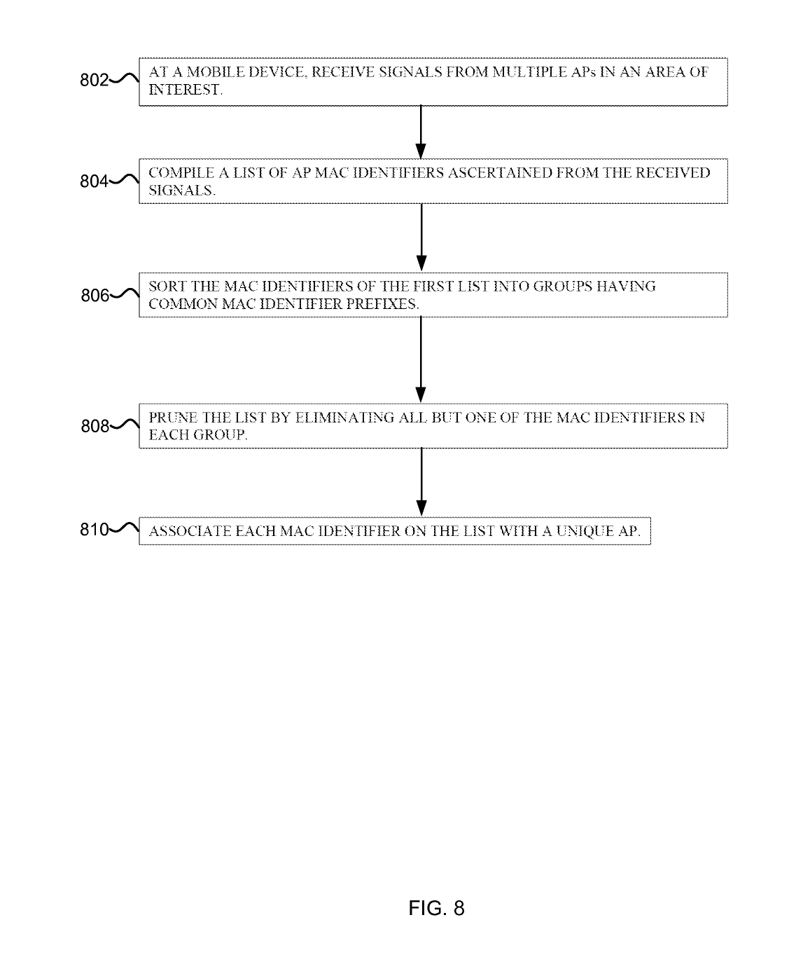

FIG. 8 is an additional flow diagram depicting an alternative example pruning algorithm that may be used when MAC addresses are used to identify detected APs and multiple MAC addresses are associated with individual APs. The algorithm detects for groups of unique MAC addresses which, for location fixing purposes, are redundant because each one, despite being distinct from all other identifiers, corresponds to the same detected AP.

MAC addresses are hexadecimal numbers having a length of 12 digits. However, the first 11 digits of the MAC address comprise a prefix which uniquely corresponds to the AP using the MAC address. Furthermore, in cases where a single AP employs multiple MAC addresses, the prefixes of all MAC addresses employed by the AT are the same.

For each group of redundant MAC addresses, the algorithm prunes all but one of the redundant addresses from the list of detected MAC addresses. In this way, if a mobile device uses the pruned list of detected MAC addresses to identify APs for use in location fixing, the mobile device will not waste resources by unnecessarily processing redundant data from an AP, as would otherwise occur if redundant MAC addresses were not pruned. The algorithm of FIG. 8 does not require a mobile device to have a priori knowledge of the location of any APs, nor does it require the device to determine any AP locations.

The algorithm of FIG. 8 begins at 802 by a mobile device receiving signals from APs in the inside area, or area of interest, as the case may be. Because some APs use several distinct MAC addresses, the mobile device may, upon receiving the signals, ascertain several unique MAC addresses which each correspond to the same AP. At 804, the mobile device compiles an initial list of all MAC addresses ascertained from the received signals. At 806, the mobile device sorts the MAC addresses on the initial list into groups having common MAC address prefixes. In this way, for each group, the MAC addresses in the group are all associated with the same AP. At 808, the mobile device prunes the initial list of MAC addresses by eliminating all but one of the MAC addresses in each group. Following the pruning, the list no longer contains MAC addresses which are associated with a common AP. Thus, computational resources are saved if only the remaining MAC addresses on the list are used to identify APs for use in mobile device location fixing. Accordingly, at 810, the mobile device associates each MAC identifier on the list with a unique AP.

Alternatively, the sorting and pruning described at 806 and 808 may be done by a remote server capable of accessing or receiving the array information used in these steps. In this case, the identities of the APs remaining on the pruned list may be communicated, using MAC addresses, to the wireless device or any other wireless entity.

As described previously, a mobile device in an indoor area or other area of interest may additionally or alternatively prune a list of access point identifiers using geometry-based pruning. Geometry based pruning involves first estimating the locations of detected APs (the detected APs may be all initially detected APs, or some number of detected APs which remain on a list that has been pruned in accordance with one of the pruning algorithms previously described). Later, pruning is done based on the estimated locations in order to provide a list of APs which are suitably positioned for use in location fixing.

To estimate the location of detected APs in an area of interest, a mobile device may determine, for each detected AP, proximity data at several locations in the area of interest. For each detected AP, a 3-dimensional heatmap is then generated using the proximity data and saved in memory. Each heatmap is generated such that the first and second dimension (referred to hereinafter as the “x dimension” and “y dimension”) are descriptive of points (or locations) in a 2-dimensional horizontal plane within the area of interest, while the third dimension (referred to hereinafter as the “z dimension”) is used to describe the proximity data detected for the AP corresponding to the heatmap.

If RSSI data is described by the z dimension, the mobile device scans the heatmap horizontally (i.e., various x,y locations are evaluated) in an effort to detect a local maximum in the z-dimension which forms a distinct “peak” topography in the heatmap. In the alternative case in which RTT data is described by the third dimension, the mobile device scans the heatmap in an effort to detect a local minimum which forms a distinct “trough” in the heatmap. The horizontal location represented by the x and y coordinates associated with a detected trough or peak, as the case may be, is then taken as the location of the AP. (RTT heatmap may be used as well. In that case the position where minimum RTT happens will be the AP location estimate.)

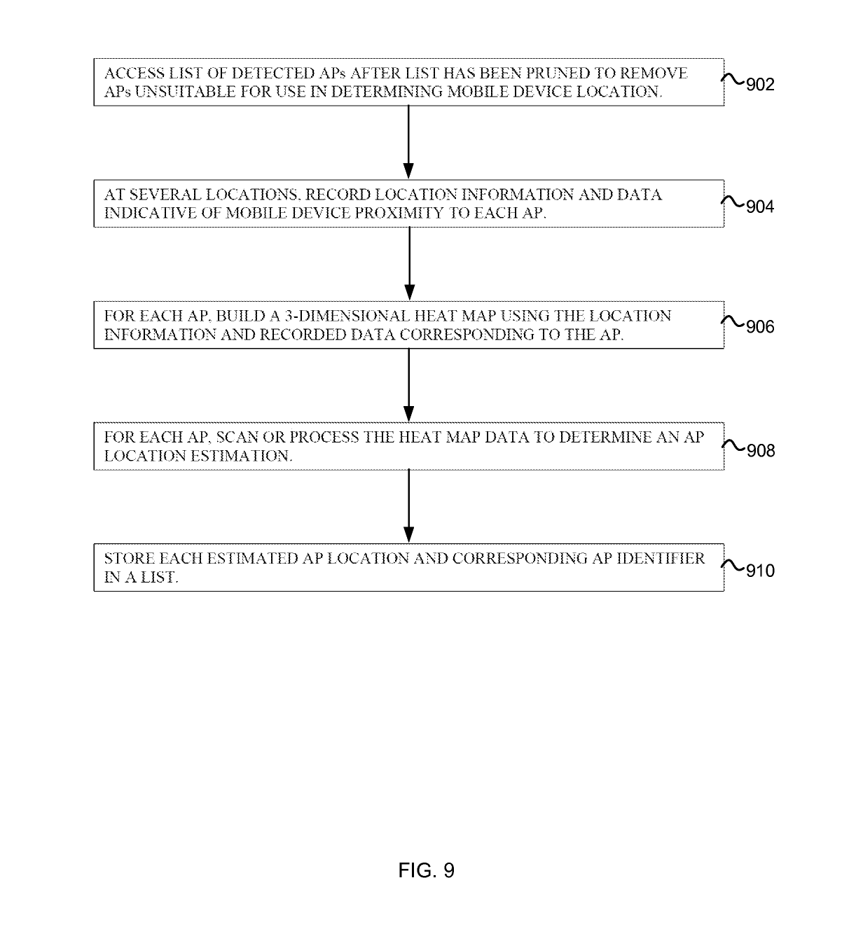

The algorithm described above for determining the location of detected APs may be further understood through reference to the flow diagram of FIG. 9. As depicted, at 902, the mobile device accesses a list of detected APs. Subsequently, the mobile device attempts, at several locations within the area of interest, to receive signals sent to or from each AP on the list. At 904, the mobile device uses these received signals to determine and save proximity data for the APs. At 906, the AP constructs a 3-dimensional heatmap for each AP based on the proximity data corresponding to the AP previously gathered at 904. At 908, the mobile device scans or processes the heatmap of each AP to determine a location estimation for the corresponding AP. At 910, the mobile device saves each estimated AP location in a list along with the AP identifier.

In one aspect of the algorithm described in FIG. 9, the mobile device may use interpolation to limit the amount of proximity data needed for generating the heat maps. By using interpolation, the mobile device can generate a heatmap which continuously covers the entire area of interest, even when the mobile device has not actually determined proximity data for the associated AP at every location corresponding to an (x,y) coordinate on the heatmap. For example, the mobile device may use received signals sent to or from an AP only to determine proximity data for an AP at locations corresponding to one of every fifth coordinate in both the x and y directions. The mobile device may then interpolate to estimate proximity data for remaining locations for which proximity data was not measured. Using both the proximity data determined from received signals and the interpolated proximity data, the mobile device can then form the heatmap for the entire area of interest.

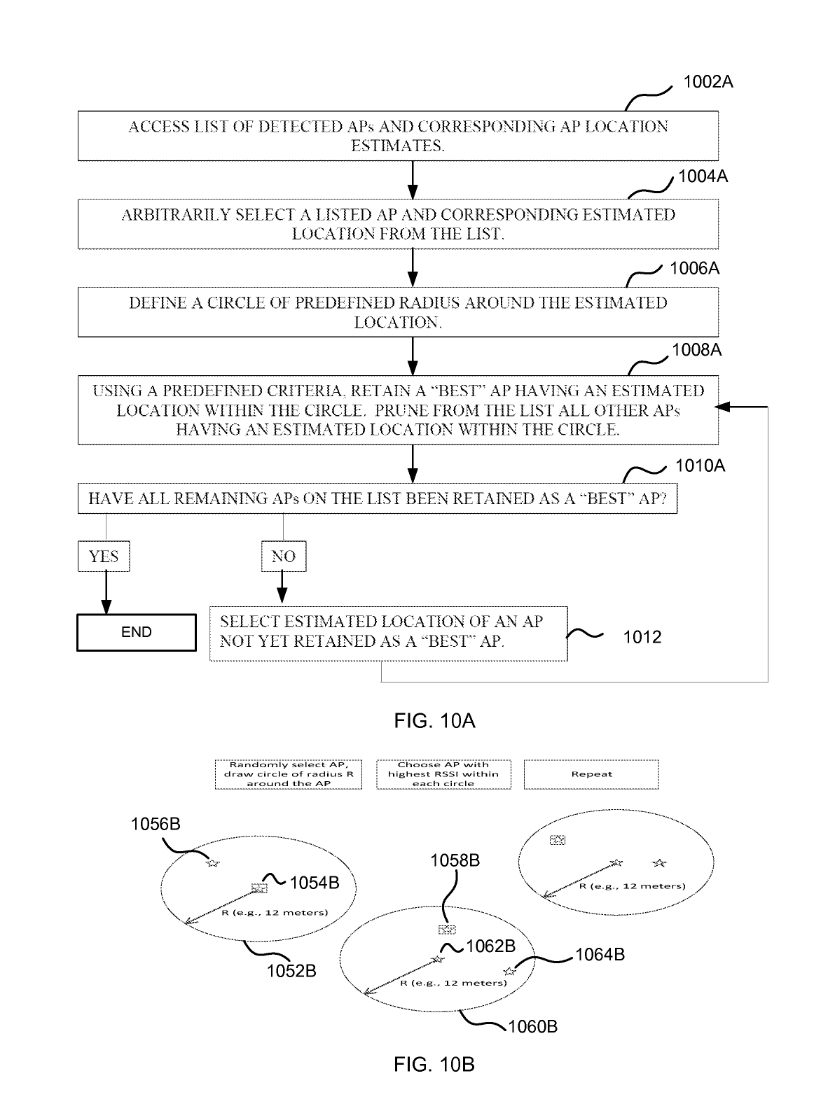

After estimating the locations of detected APs, the mobile device may use the estimated AP locations to prune APs from the list of detected APs so as to provide an appropriately sized list of APs which are suitable for mobile device location fixing. There are several different algorithms that may be used for pruning based on the estimated AP locations. One such algorithm, which is described by FIG. 10A, involves the use of centroids to prune APs which are clustered in a same area as other APs remaining on the list. The centroid algorithm enables a mobile device to generate a pruned list containing, in general, only APs which dispersed throughout the area of interest. In this way, adequate fixing information can be efficiently obtained at most or all locations in the area.

To execute a centroid pruning algorithm in accordance with this disclosure, a mobile device first determines a distance sensitivity parameter (hereinafter referred to as the “predefined separation”). The value of the predefined separation influences the amount of spacing that will exist between neighboring APs that are retained during the pruning process. In general, a higher predefined separation will result in fewer retained APs, and greater distance between any two neighboring APs.

Once the predefined separation is determined, the mobile device accesses the list of detected APs and the estimated location of each AP on the list, as depicted at 1002A. Then, at 1004A, the device compares proximity data for each AP in a group of APs consisting of an arbitrarily chosen one of the detected APs on the list, and all other detected APs on the list which are estimated to be separated from the chosen AP by less than the predefined separation. That is, the comparison group can be thought of as including all APs on the list which are estimated to be located within a circle of radius equal to the predefined separation, which is centered around the estimated location of the chosen AP. Hereinafter, such a circular area around a randomly selected AP will be referred to as a “comparison circle”.

For explanatory purposes, this paragraph refers ahead to FIG. 10B, which depicts several aspects of the centroid pruning algorithm by showing results of centroid pruning after several iterations of the algorithm. It is worth noting that FIG. 10B depicts example results for one case in which a predefined separation of 12 meters was used. At 1052B, the mobile device has arbitrary selected the AP 1054B and compared this AP with AP 1056B. In this case, AP 1054B and AP 1056B are the only APs with estimated location within the comparison circle centered about the estimated position of AP 1054B.

Referring once again to FIG. 10A, the comparison of the proximity data of each AP in the comparison circle group is used as the basis for selecting and retaining a “best” AP from the group. This selection occurs at 1008A of the algorithm. Comparison and selection may be done using one of several different methodologies. For example, the mobile device may access each heatmap corresponding to an AP in the comparison group. These heatmaps may be analyzed to find the map which contains the highest RSSI values at and/or around the estimated location of the AP corresponding to the map. This comparison may be based on an average of RSSI values recorded at or around the coordinate of an estimated AP location, a single most extreme RSSI value, a weighted average metric, or some other similar data analysis metric.

Alternatively, if the heat maps depict RTT data, each heatmap may be analyzed to find the map containing the smallest RTTs at the estimated location of the AP corresponding to the map. The AP determined to be the best AP within the group is retained on the list of detected APs, while all other APs are pruned from the list.

Referring again to FIG. 10B, AP 1054B is depicted as previously determined to be a best AP within its corresponding comparison circle. This fact is indicated by the square shape used to mark its position. Because AP 1054B is a best AP, it has not been pruned from the list of detected APs. Also, AP 1056B was compared to AP 1054B as part of the same comparison circle group. Because AP 1056B was not selected as the best AP in this comparison, its estimated position is marked by the star shape to indicate its removal from the list.

Referring back to FIG. 10A, at 1010A, the mobile device determines if there are remaining APs on the list which have yet to be involved in a groupwise comparison. If not, one such remaining AP is arbitrarily chosen at 1012A, and a “best” AP is again selected at 1008A from amongst all remaining APs having estimated location within a comparison circle centered on the newly chosen AP. This best AP is retained on the list, while the other APs compared against it are pruned from the list.

FIG. 10B also shows a result of one such second groupwise comparison and retention of a best AP as part of the depicted execution of the centroid pruning algorithm. The APs from which the second comparison group was formed are indicated by comparison circle 1060B. As depicted, APs 10058B, 1062B and 1064B were compared, and AP 1058B was retained as the best AP within this comparison group. Accordingly, the estimated position of AP 1058B is identified by a square symbol to indicate its retention on the list, and APs 1052B and 1054B are identified by star symbols to indicate that these APs were pruned from the list.

The comparison and pruning process described above is continued until each AP remaining on the list has been determined to be a best AP through a groupwise comparison. Once the list contains only best APs, signals from the APs remaining on the list may be used by the mobile device to conduct location fixing.

As described previously, an external network entity may be used to implement aspects of the present disclosure through communication with a wireless device or other entity operating in the area of interest for mobile device location fixing. In an embodiment, such an external entity may be used to identify the limited group of APs suitable for accurate and reliable mobile device fixing in the area of interest. For example, the external entity may receive a list of detected APs in the area of interest and proximity data related to the APs. This data and information may be sent to the external device in real time, immediately after being determined or calculated. Alternatively, it may be accumulated and stored by another entity, consolidated with other information, and then sent to the external entity.

The external entity may store this data in memory and perform calculations using the data. Moreover, the external entity may use any number of the pruning algorithms or methods presented herein to determine a limited list of APs suitable for accurate and reliable fixing in the area of interest. The external algorithm may identify, track, and refer to APs using MAC addresses. Moreover, the external entity may accumulate AP identification and proximity data communicated to it by more than one device operating in the area of interest. The external entity may use this data to determine historical trends and use information about the trends to adjust algorithmic parameters or the combination of algorithms it uses to determine groups of suitable APs.

Alternatively, execution of certain of the algorithms and calculations described above for use in geometry-based pruning may be done by a remote server or other entity capable of accessing the mobile device location information and proximity data involved in the calculations. In this case, the identities of the APs remaining on the pruned list may be communicated, using MAC addresses, to the wireless device or any other wireless entity.

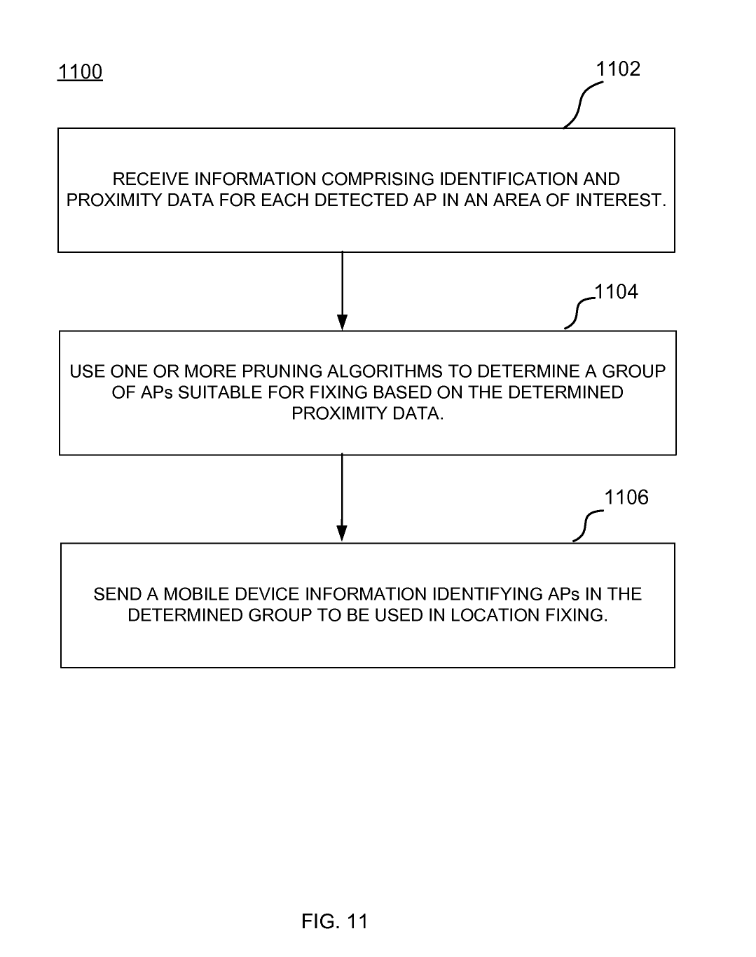

FIG. 11 is a flow diagram depicting general methods for employing an external entity to determine a group of APs which are suitable for use in location fixing. As depicted, at 1102 an external device receives information identifying detected APs in an area of interest and receives proximity data for each detected AP. As described previously, this information may include MAC addresses which correspond to individual AP at the area of interest. The proximity data may include RSSI data or RTT data.

At 1104, the external entity may then use the received data and identification information to determine a group of APs in the area of interest, which, when used together, are suitable for mobile device fixing. At 1106, the mobile device sends information to a mobile device at the area of interest. The information identifies the APs in the determined group using MAC addresses or some other identifying format. Alternatively, the identifying information may be sent to a data relaying or storage entity at the area of interest. A relay or storage entity receiving the information may then provide it to numerous wireless devices, and may save the information for distribution to wireless devices which enter the area of interest at a future time.

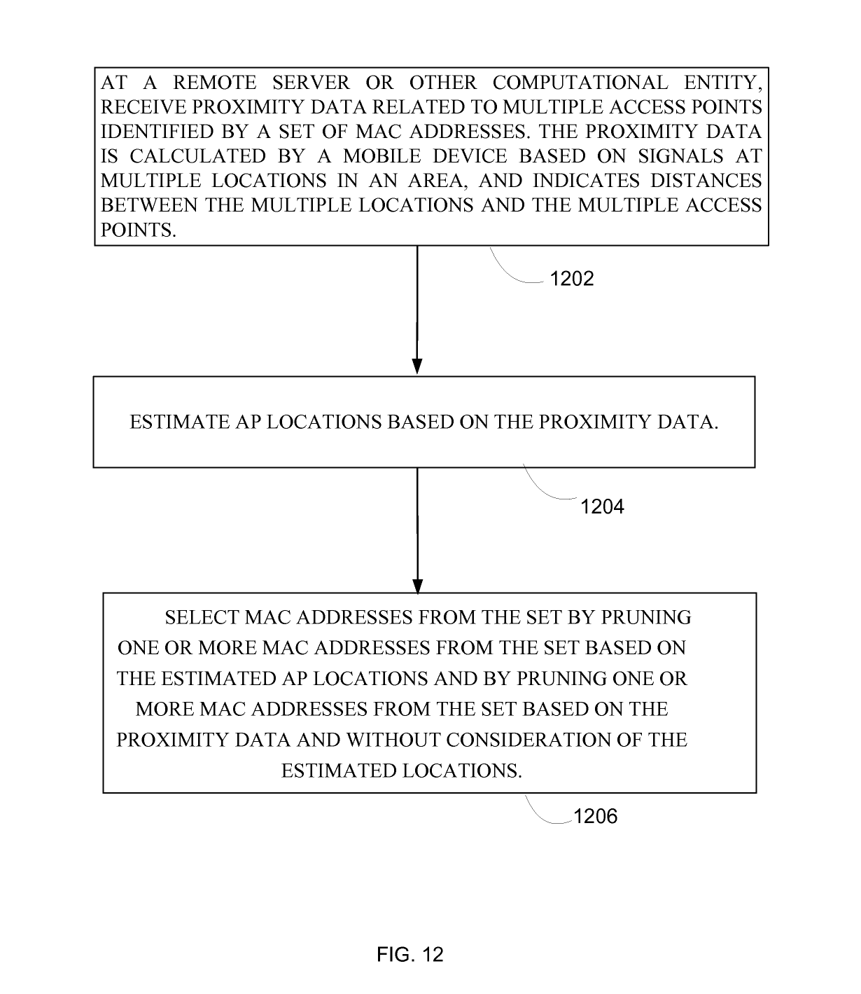

FIG. 12 is a flow diagram summarizing one generalized example sequence of operations that may be performed by a remote server, computer or other computational system (hereinafter “remote server”) in accordance with the present disclosure. The remote server may be interoperable with a wireless measurement device or other wireless devices, and may be configured to communicate with the wireless devices so that it may execute one or more of the aforementioned algorithms for determining the limited number of APs which are suitable for mobile device fixing. At 1202, the remote server receives proximity data related to multiple detected access points identified by a set of MAC addresses. This received proximity data is previously calculated or gathered by a mobile device based on signals at multiple locations in an area. Furthermore, the proximity data indicates distances between the multiple locations and the multiple access points.

At 1204, the remote server estimates the locations of the APs identified by the received MAC addresses. Estimating the locations is based on the received proximity data, in accordance with one or more of the algorithms previously described herein.

At 1206, the remote server selects MAC addresses by pruning one or more MAC addresses from the set. The pruning is based on the AP locations estimated at 1204. The selection of MAC addresses also entails pruning one or more MAC addresses from the set based on the proximity data and without consideration of the locations estimated at 1204.

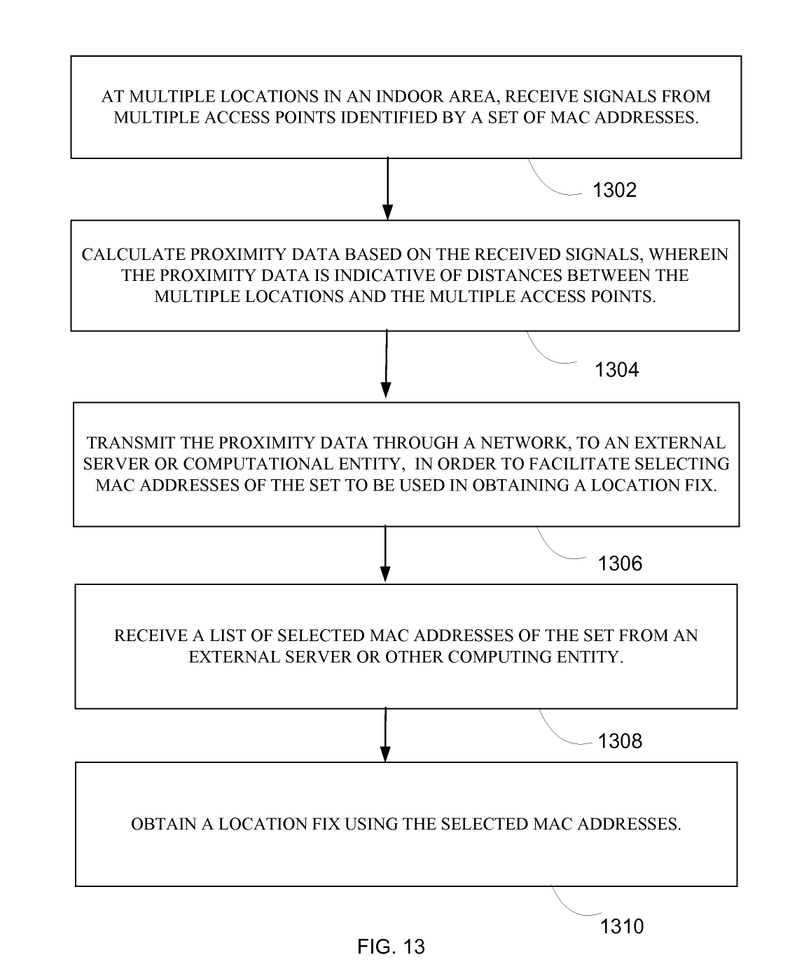

FIG. 13 is a flow diagram summarizing one generalized example sequence of operations that may be performed by a wireless device in accordance with the present disclosure. At 1302, the wireless device receives signals, at multiple locations, from multiple access points in an indoor area or other area where mobile device location fixing is desired. The multiple access points are identified by a set of MAC addresses. At 1304, the mobile device calculates proximity data based on the received signals. The proximity data is indicative of distances between the multiple locations and the multiple access points. Subsequently, at 1306, the mobile device transmits the proximity data through a network to facilitate selecting MAC addresses of the set for subsequent use by a mobile device in obtaining a location fix. At 1308, the mobile device receives a list of the selected MAC addresses and obtains a location fix using the selected MAC addresses at 1310.

Implementations or embodiments of the description herein and/or the attached figures may allow operators to deploy an improved location service that can be available to both home users and roamers. Charging for the service is possible using ciphering. The service can provide augmentation of other broadcast services from an operator.

The methods, systems, devices, implementations, and embodiments discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “capable of”, “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method for selecting access points (APs) for use in obtaining a location fix for a mobile device comprising:
receiving proximity data related to multiple access points identified by a set of MAC addresses, the proximity data calculated by a mobile device based on signals received at multiple locations in an indoor area, wherein the proximity data is indicative of distances between the multiple locations and the multiple access points;
estimating AP locations based on the proximity data;
selecting MAC addresses from the set, wherein selecting comprises:
pruning one or more MAC addresses from the set based on the estimated AP locations; and
pruning one or more MAC addresses from the set based on the proximity data.

2. The method of claim 1, further comprising transmitting information to a mobile device, the information identifying the selected MAC addresses.

3. The method of claim 2, wherein pruning based on the proximity data comprises:
determining a correlation between proximity data corresponding to a first MAC address of the set and proximity data corresponding to a second MAC address of the set; and
pruning one or more MAC addresses from the set based on the correlation.

4. The method of claim 2, wherein the proximity data comprises:
early proximity data calculated based on signals transmitted by an access point at a first time; and
later proximity data calculated based on signals transmitted by said access point at a second time later than the first time;
and wherein pruning based on the proximity data comprises pruning based on a correlation between the early proximity data and the later proximity data or pruning based on an amount of difference between the early proximity data and later proximity data.

5. The method of claim 2, wherein selecting MAC addresses from the set further comprises:
accessing data related to the manufacture of an access point associated with a MAC address of the set;
pruning a MAC address from the set based on the data related to the manufacture.

6. The method of claim 2, wherein the proximity data comprises round trip time data and received signal strength data.

7. The method of claim 2, wherein selecting MAC addresses from the set further comprises pruning a MAC address from the set based on the availability of round trip time information associated with the MAC address.

8. The method of claim 2, wherein pruning MAC addresses based on the estimated locations further comprises:
determining multiple sub-regions within the indoor area;
for each sub-region, selecting one MAC address corresponding to an AP with an estimated location in the sub-region, wherein the selecting comprises comparing:
proximity data corresponding to the selected MAC address; and
proximity data corresponding to other MAC addresses of the set, each of the other MAC addresses corresponding to an AP having an estimated location in the sub-region.

9. The method of claim 2, wherein selecting access points from the set further comprises:
accessing the set of MAC addresses;
placing the MAC addresses into groups consisting of MAC addresses with common prefixes; and
selecting one MAC address from each of the groups.

10. An apparatus for selecting access points (APs) for use in obtaining a location fix for a mobile device, the apparatus comprising:
one or more processors configured to:
receive proximity data calculated by a mobile device, the proximity data associated with multiple access points identified by a set of MAC addresses, and the proximity data calculated based on signals received at multiple locations in an indoor area, wherein the proximity data is indicative of distances between the multiple locations and the multiple access points;
estimate AP locations based on the proximity data; and
select MAC addresses from the set, wherein the one or more processors are further configured to select MAC addresses from the set by:
pruning one or more MAC addresses from the set based on the estimated AP locations; and
pruning one or more MAC addresses from the set based on the proximity data; and
a memory coupled to the one or more processors.

11. The apparatus of claim 10, wherein the one or more processors are further configured to:
transmit information to a mobile device, the information identifying the selected MAC addresses.

12. The apparatus of claim 11, wherein the one or more processors are further configured to prune by:
determining a correlation between proximity data corresponding to a first MAC address of the set and proximity data corresponding to a second MAC address of the set; and
pruning one or more MAC addresses from the set based on the correlation.

13. The apparatus of claim 11, wherein the proximity data comprises:
early proximity data calculated based on signals transmitted by an access point at a first time; and
later proximity data calculated based on signals transmitted by said access point at a second time later than the first time;
and wherein the one or more processors are further configured to prune based on the proximity data by pruning based on a correlation between the early proximity data and the later proximity data or by pruning based on an amount of difference between the early and later proximity data.

14. The apparatus of claim 11, wherein the one or more processors are configured to select MAC addresses from the set by further:
accessing data related to the manufacture of an access point associated with a MAC address of the set; and
pruning a MAC address from the set based on the data related to the manufacture.

15. The apparatus of claim 11, wherein the proximity data comprises round trip time data or received signal strength data.

16. The apparatus of claim 11, wherein the one or more processors are configured to select MAC addresses from the set by further pruning MAC addresses from the set based on the availability of round trip time information associated with the MAC address.

17. The apparatus of claim 11, wherein the one or more processors are further configured to prune MAC addresses based on the estimated locations by:
determining multiple sub-regions within the indoor area;
for each sub-region, selecting one MAC address corresponding to an AP with an estimated location in the sub-region, wherein the one or more processors are further configured to select one MAC address by comparing:
proximity data corresponding to the selected MAC address; and
proximity data corresponding to other MAC addresses of the set, each of the other MAC addresses corresponding to an AP having an estimated location in the sub-region.

18. The apparatus of claim 11, wherein the one or more processors are further configured to select access points from the set by:
accessing the set of MAC addresses;
placing the MAC addresses into groups consisting of MAC addresses with common prefixes; and
selecting one MAC address from each of the groups.

19. An apparatus for selecting access points (APs) for use in obtaining a location fix for a mobile device, the apparatus comprising:
means for receiving proximity data calculated by a mobile device, the proximity data associated with multiple access points identified by a set of MAC addresses, and the proximity data calculated based on signals received at multiple locations in an indoor area, wherein the proximity data is indicative of distances between the multiple locations and the multiple access points;
means for estimating AP locations based on the proximity data;
means for selecting MAC addresses from the set, wherein the means for selecting comprises:
means for pruning one or more MAC addresses from the set based on the estimated AP locations; and
means for pruning one or more MAC addresses from the set based on the proximity data.

20. The apparatus of claim 19, further comprising means for transmitting information to a mobile device, the information identifying the selected MAC addresses.

21. The apparatus of claim 20, wherein the means for pruning based on the proximity data comprises:
means for determining a correlation between proximity data corresponding to a first MAC address of the set and proximity data corresponding to a second MAC address of the set; and
means for pruning one or more MAC addresses from the set based on the correlation.

22. The apparatus of claim 20, wherein the proximity data comprises:
early proximity data calculated based on signals transmitted by an access point at a first time; and
later proximity data calculated based on signals transmitted by said access point at a second time later than the first time;
and wherein the means for pruning based on the proximity data comprises means for pruning based on a correlation between the early proximity data and the later proximity data or means for pruning based on an amount of difference between the early and later proximity data.

23. The apparatus of claim 20, wherein the means selecting MAC addresses from the set further comprises:
means for accessing data related to the manufacture of an access point associated with a MAC address of the set; and
means for pruning a MAC address from the set based on the data related to the manufacture.

24. The apparatus of claim 20, wherein the proximity data comprises round trip time data or received signal strength data.

25. The apparatus of claim 20, wherein the means selecting MAC addresses from the set further comprises means for pruning MAC addresses from the set based on the availability of round trip time information associated with the MAC address.

26. The apparatus of claim 20, wherein the means for pruning MAC addresses based on the estimated locations comprises:
means for determining multiple sub-regions within the indoor area;
means for selecting, for each sub-region, one MAC address corresponding to an AP with an estimated location in the sub-region, wherein said means for selecting comprises means for comparing:
proximity data corresponding to the selected MAC address; and
proximity data corresponding to other MAC addresses of the set, each of the other MAC addresses corresponding to an AP having an estimated location in the sub-region.

27. The apparatus of claim 20, wherein the means for selecting access points from the set further comprises:
means for accessing the set of MAC addresses:
means for placing the MAC addresses into groups consisting of MAC addresses with common prefixes; and
means for selecting one MAC address from each of the groups.

28. A computer program product for causing a computer to select access points (APs) for use in obtaining a location fix for a mobile device, the computer program product comprising:
a non-transitory computer-readable medium having instructions stored thereon, the instructions operable for causing the computer to:
receive proximity data calculated by a mobile device, the proximity data associated with multiple access points identified by a set of MAC addresses, and the proximity data calculated based on signals received at multiple locations in an indoor area, wherein the proximity data is indicative of distances between the multiple locations and the multiple access points;
estimate AP locations based on the proximity data; and
select MAC addresses from the set, wherein the instructions operable for causing the computer to select MAC addresses comprise instructions operable for causing the computer to select MAC addresses by:
pruning one or more MAC addresses from the set based on the estimated AP locations; and
pruning one or more MAC addresses from the set based on the proximity data.

29. The computer program product of claim 28, wherein the computer-readable medium further comprises instructions operable to cause the computer to:
transmit information to a mobile device, the information identifying the selected MAC addresses.

30. The computer program product of claim 29, wherein the instructions operable for causing the computer to prune based on the proximity data further comprise instructions operable for causing the computer to prune by:
determining a correlation between proximity data corresponding to a first MAC address of the set and proximity data corresponding to a second MAC address of the set; and
pruning one or more MAC addresses from the set based on the correlation.

31. A method for obtaining a list of access points (APs) selected for use in obtaining a location fix for a mobile device, the method executable by a mobile device and comprising:
at multiple locations in an indoor area, receiving signals from multiple access points identified by a set of MAC addresses;
calculating proximity data based on the received signals, wherein the proximity data is indicative of distances between the multiple locations and the multiple access points;
transmitting the proximity data through a network;
receiving a list of selected MAC addresses of the set; and
determining a location fix using the selected MAC addresses.

32. The method of claim 31, wherein calculating the proximity data comprises:
calculating early proximity data based on signals transmitted by an access point at a first time; and
calculating later proximity data based on signals transmitted by said access point at a second time later than the first time,
and wherein pruning based on the proximity data comprises pruning based on a correlation between the early proximity data and the later proximity data or pruning based on an amount of difference between the early proximity data and the later proximity data.

33. The method of claim 31, wherein the proximity data comprises round trip time data and received signal strength data.

34. The method of claim 31, wherein selecting MAC addresses from the set further comprises pruning MAC addresses from the set based on the availability of round trip time information associated with the MAC address.

35. The method of claim 31, wherein pruning MAC addresses based on the estimated locations further comprises:
determining multiple sub-regions within the indoor area;
for each sub-region, selecting one MAC address corresponding to an AP with an estimated location in the sub-region, wherein the selecting comprises comparing:
proximity data corresponding to the selected MAC address; and
proximity data corresponding to other MAC addresses of the set, each of the other MAC addresses corresponding to an AP having an estimated location in the sub-region.

36. The method of claim 31, wherein selecting access points from the set further comprises:
accessing the set of MAC addresses:
placing the MAC addresses into groups consisting of MAC addresses with common prefixes; and
selecting one MAC address from each of the groups.

37. An apparatus configured to obtain a list of access points (APs) selected for use in obtaining a location fix for a mobile device, the apparatus comprising:
a receiver configured to receive signals from multiple access points at multiple locations in an indoor area, the multiple access points identified by a set of MAC addresses;
a processor configured to calculate proximity data based on the received signals, wherein the proximity data is indicative of distances between the multiple locations and the multiple access points; and
a transmitter for transmitting the proximity data through a network;
wherein the receiver is further configured to receive a list of selected MAC addresses of the set, and the processor is further configured to determine a location fix using the selected MAC addresses.

38. The apparatus of claim 37, wherein the processor is configured to calculate the proximity data by:
calculating early proximity data based on signals transmitted by an access point at a first time; and
calculating later proximity data based on signals transmitted by said access point at a second time later than the first time.

39. The apparatus of claim 37, wherein the proximity data comprises round trip time data and received signal strength data.

40. An apparatus configured to obtain a list of access points (APs) selected for use in obtaining a location fix for a mobile device, the apparatus comprising:
means for receiving signals from multiple access points at multiple locations in an indoor area, the multiple access points identified by a set of MAC addresses;
means for calculating proximity data based on the received signals, wherein the proximity data is indicative of distances between the multiple locations and the multiple access points;
means for transmitting the proximity data through a network;
means for receiving a list of selected MAC addresses of the set; and
means for determining a location fix using the selected MAC addresses.

41. The apparatus of claim 40, wherein the proximity data comprises round trip time data or received signal strength data.

42. The apparatus of claim 41, further comprising means for transmitting manufacture information related to one of the multiple APs.

43. A computer program product comprising a non-transitory computer-readable medium, the computer-readable medium having instructions stored thereon, the instructions operable to cause a computer to:
receive signals from multiple access points at multiple locations in an indoor area, the multiple access points identified by a set of MAC addresses;
calculate proximity data based on the received signals, wherein the proximity data is indicative of distances between the multiple locations and the multiple access points;
transmit the proximity data through a network to facilitate selecting MAC addresses of the set to be used in obtaining a location fix;
receive a list of selected MAC addresses of the set; and
determine a location fix using the selected MAC addresses.

44. The computer program product of claim 43, wherein the instructions operable to cause the computer to calculate the proximity data are operable to cause the computer to calculate the proximity data by:
calculating early proximity data based on signals transmitted by an access point at a first time; and
calculating later proximity data based on signals transmitted by said access point at a second time later than the first time.
